(19) United States
(12) Patent Application Publication
(10) Pub. No.: US 2007/0139952 A1
(43) Pub. Date: Jun. 21, 2007

(54) Backlight module and liquid crystal display device using the same

(75) Inventor: Ming-Hung Tsai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/642,041

(22) Filed: Dec. 18, 2006

(30) Foreign Application Priority Data
Dec. 16, 2005 (TW) 94144819

(51) Int. Cl. F21V 7/04

(52) U.S. Cl. 362/561

(57) ABSTRACT

An exemplary backlight module and a liquid crystal display device using the backlight module are provided. The backlight module includes a light beam generator and a reflector. The light beam generator includes a light source, a polygon mirror and an f-theta lens. The polygon mirror reflects light beams into a scanning light beam which can rotate at a certain speed. The scanning light beam transmits through the f-theta lens, and then it is transferred into parallel scanning beams. The parallel scanning beams reach the reflector. A light source device to produce a scanning light beam is also provided. The light source device can improve the uniformity of emission of the backlight module.

### BACKGROUND OF THE INVENTION

1. Field of the Invention

The invention relates to a backlight unit, and particularly a display system applied the backlight unit.

2. General Background

A liquid crystal display (LCD) is one kind of display system that cannot produce illumination for a displayed image by itself. Therefore in order to display images, a planar light source (e.g. a backlight unit) is usually provided with an LCD panel. The backlight unit is configured with the LCD panel so as to provide a bright and uniform planar light source. Two types of backlight unit (i.e. side edge type and direct type) are well-known in this field.

Backlight unit of side edge type is illustrated below. The side edge type backlight is always in bright state and mounted aside to the light guide plate for the LCD module so as to transmit light beam to LCD panel. The LCD panel usually includes a so-called upper substrate and a lower substrate. The pixel electrode (at the lower substrate) and the common electrode (at the upper substrate) cooperatively constitute a capacitor. During display images, each scan signal coming from the corresponding gate electrode is proceeded a scan process upon each column of pixels sequentially. At the moment of changing different scanning columns, light beam cannot be exactly controlled due to the capacitor's effect according to the scanning signals applied to the corresponding pixels in a predetermined manner that the contrast of display images is decreased. Furthermore, due to mutually reinforcing of lower response time for liquid crystal molecules and the persistence of vision in human eyes, the blurred image of object movement of image display and the contrast in boundary shape of the displaying object became worse are occurred.

In the other case, a typical direct type backlight unit is described as follows. Several cold cathode fluorescent lamps (CCFLs) are set under the light guide plate of the LCD module. In order to overcome the weakness of side edge type backlight, the timing signals from timing controller are used to turn on or turn off the foregoing CCFLs so as to control the light beams introduced to the LCD panel in accordance with the timing signals.

Referring to FIG. 6, this is an exploded, side cross-sectional view of a conventional LCD device 1. The LCD device mainly includes a backlight 10 and an LCD panel 17. The backlight 10 generally includes a light guide plate (LGP) 11, a plurality of CCFLs 12, a reflector 13, a light source cover 14, a diffuser sheet 15 and a prism sheet 16. The LGP 11 is a rectangle plate including a light entrance surface 111 and a light exit surface 112. The CCFLs 12 are set uniformly under the light entrance surface 11 side of the LGP 11. The light source cover 14 has an accommodating space which is to receive the CCFLs 12 and the reflector 13. The reflector 13 is set between the light source cover 14 and the CCFLs 12. The LGP 11 is set above the light source cover 14. The diffuser sheet 15 and the prism sheet 16 are stacked on the light exit surface 112 side of the LGP 11, in that order.

The display process of the LCD device 1 is as follows. A timing signal is provided to control the turn on and turn off of the CCFLs 12. The frequency of the timing signal synchronizes with the frequency of the gate scanning signal of the LCD panel 17. The scan light beams are obtained from the scan process achieved by CCFLs 12. The light beams transmit through the LGP 11, the diffuser sheet 15 and the prism sheet 16 sequentially and eventually reach the LCD panel 17 so as to provide light for display.

When the direct type of backlight is configured to introduce light for LCD panel 17 to display, the scan light beams vary with the scanning signal so as to increase the contrast of the LCD panel 17. Therefore, some serious problems occurred in side edge type of backlight such as, the blurred image of object movement of image display and the contrast in boundary shape of the displaying object became worse can be reduced. However, each CCFLs 12 is corresponding many pixel regions that the dark state and bright state of the CCFLs 12 cannot match the status of pixel regions precisely. Therefore, this type of backlight still exhibits a contrast problem. Moreover, the brightness upon the area between each two CCFLs 12 is a little darker than other areas having CCFLs 12 below that the light uniformity of the LCD panel cannot be achieved.

Furthermore, the starting voltage of the CCFL is higher than the normal work voltage thereof. Additionally, in order to meet the basic requirement of image display for the LCD device, the frequency of turning on and turning off of the CCFL might be higher than 25 times per second. This situation might reduce the life of the CCFLs.

### SUMMARY

An exemplary light beam generator is used in a backlight module for a display device. The light beam generator includes a light source, a multi-surface rotating mirror, a flattened lens (collimator lens), two optical detectors, a gray filter, and a lens array. The multi-surface rotating mirror (also known as a polygon mirror) is configured to provide a predetermined rotating frequency so as to reflect light beams from the light source. The flattened lens is adopted to transform the reflecting light beams to parallel light beams. In the exemplary embodiment, the two optical detector set on two end of the flattened lens, the optical detector is configured to detect light beams and generate feedback signals so as to control the rotating frequency of the multi-surface rotating mirror.

An exemplary backlight module is configured to provide light to a display device. The backlight module usually includes a light beam generator, a gray filter, a lens array, a light guide plate (LGP), a diffuser sheet, a prism sheet, and a reflector. The light beam generator includes a light source, a multi-surface rotating mirror, a flattened lens, two optical detectors, a gray filter, and a lens array. The multi-surface rotating mirror (also known as a polygon mirror) is configured to rotate at a predetermined frequency so as to reflect light beams from the light source. The flattened lens is adapted to transform the reflecting light beams to parallel light beams. In the exemplary embodiment, the two optical detectors set on both end of the flattened lens, the optical detectors are configured to detect light beams and generate feedback signals to the PCB according to a scanning frequency of light beam reflecting from the multi-surface rotating mirror. Therefore, the frequency of the scanning light beams is corresponding to the frequency of the scanning signal. During the rotating process of the polygon mirror, when the scanning signal is applied to the LCD panel, the scanning light beams scan the LGP one or more than one time. By using this technique, the blurred image of object movement of image display and the contrast in boundary shape of the displaying object became worse can be reduced.

An exemplary liquid crystal display (LCD) device includes an LCD panel, a backlight module and a printed circuit board (PCB). The PCB is at least mounted with a driving signal generator and a timing controller configured to provide scanning signals and timing signals. The backlight module usually includes a light beam generator, a gray filter, a lens array, a light guide plate (LGP), a diffuser sheet, a prism sheet, and a reflector. The light beam generator includes a light source, a multi-surface rotating mirror, a flattened lens, two optical detectors, a gray filter, and a lens array. The multi-surface rotating mirror (also known as a polygon mirror) is configured to rotate at a predetermined frequency so as to reflect light beams from the light source. The flattened lens is adapted to transform the reflecting light beams to parallel light beams. In the exemplary embodiment, the two optical detectors set on both end of the flattened lens, the optical detector is configured to detect light beams and generate feedback signals to the PCB according to a scanning frequency of light beam reflecting from the multi-surface rotating mirror. Therefore, the frequency of the scanning light beams is corresponding to the frequency of the scanning signal. During the rotating process of the polygon mirror, when the scanning signal is applied to the LCD panel, the scanning light beams scan the LGP one or more than one time. By using this technique, the blurred image of object movement of image display and the contrast in boundary shape of the displaying object became worse can be reduced.

On the other hand, a total reflection prism can set to replace the aforesaid elements, the gray filter and the lens array. The total reflection prism can be set aside the light entrance surface of the LGP wherein the total reflection prism is figured as an isosceles right triangle and a bevel of the total reflection prism faces the light entrance surface of the LGP. Therefore, a parallel scanning light beam can be provided. Furthermore, the other type of light source can be adopted to provide polarized light beams. If the light source provides the polarized light beams, a polarized beam splitter and a beam combiner should be needed.

Advantages and novel features of the above-described devices and systems will become more apparent from the following detailed description when taken in conjunction with the accompanying drawings. In the drawings, all the views are schematic.

### BRIEF DESCRIPTION OF THE DRAWINGS

FIG. 1 is a plan view of a liquid crystal display (LCD) device illustrating a first embodiment of the present invention.

FIG. 2 is an enlarged, side plan view of a marked area III of FIG. 1.

FIG. 3 is a plan view of an LCD device illustrating a second embodiment of the present invention.

FIG. 4 is a plan view of an LCD device illustrating a third embodiment of the present invention.

FIG. 5 is an exploded, side plan view of an LCD device illustrating a fourth embodiment of the present invention.

FIG. 6 is an exploded, side cross-sectional view of a conventional LCD device.

### DETAILED DESCRIPTION OF PREFERRED EMBODIMENTS

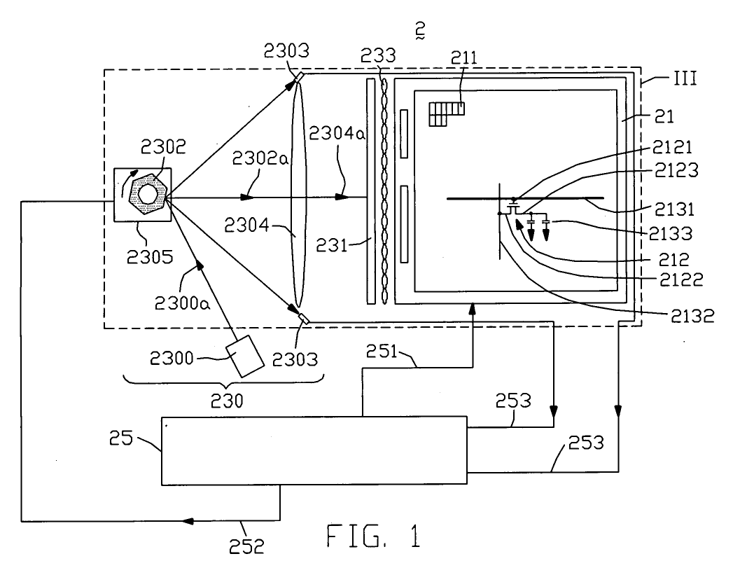

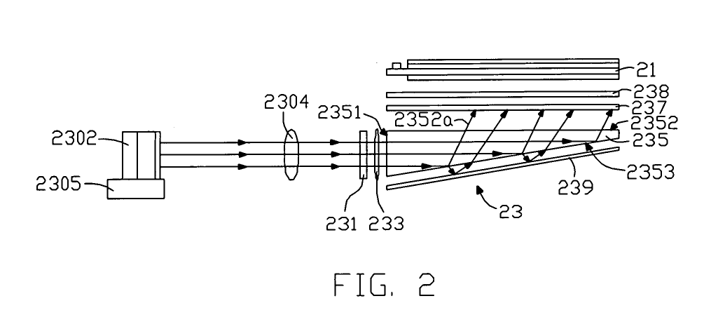

FIG. 1 is a schematic plan view of a liquid crystal display (LCD) device illustrating a first embodiment of the present invention. FIG. 2 is an enlarged, side plan view of a marked area III of FIG. 1. The LCD device 2 mainly includes an LCD panel 21, a backlight module 23 and a printed circuit board (PCB) 25. The LCD panel 21 and the backlight module 23 are stacked with each other and the PCB 25 electrically connects to the LCD panel 21 and the backlight module 23.

As shown in FIG. 2, the backlight module 23 usually includes a light beam generator 230, a gray filter 231, a lens array 233, a light guide plate (LGP) 235, a diffuser sheet 237, a prism sheet 238, and a reflector 239. The LGP 235 can be a plastic plate with wedge shape, which includes a light entrance surface 2351, a light exit surface 2352, and a bottom 2353. The LGP 235 is used to introduce light beams to transmit from the light entrance surface 2351 to the light exit surface 2352.

The light beam generator 230 can generate scanning light beams with specific scanning frequency, and includes a light source 2300, a polygon mirror 2302, two optical detectors 2303, an f-theta lens 2304, and a driving motor 2305. In the exemplary embodiment, the light source 2300 can be a white light LED, which is set at a side of the polygon mirror 2302 and emits light directly toward the polygon mirror 2302. The polygon mirror (i.e. a multi-surface rotating mirror) 2302 can be a polygon prism, with each surface of the polygon prism being a reflector. The polygon mirror 2302 can be driven by the driving motor 2305. The f-theta lens (i.e. a flattened lens) 2304 can be a convex lens that is used to transform a dispersing light to a parallel light beam. The f-theta lens 2304 is set between the polygon mirror 2302 and the gray filter 231. The optical detector 2303 is used to detect the strength of light and also generates a feedback signal. The two optical detectors 2303 are arranged on the two sides of the f-theta lens 2304 and are electrically connected to the PCB 25.

The gray filter 231 is used to uniform the strength of light when light passes through the gray filter 231. The lens array 233 is also used to uniform the strength of light. When light passes through the lens array 233, the brightness of light coming from the central region of the lens array 233 probably approaches the brightness of light coming from the peripheral region thereof so as to increase total brightness as much as about 40%.

The optical transmission path of the backlight module 23 in the exemplary embodiment of the present invention is described as follows. The light source 2300 emits light beam 2300a to one surface of the polygon mirror 2302. The polygon mirror 2302 rotates with a predetermined frequency under driving by the driving motor 2305. The light beams 2300a are reflected through the polygon mirror 2302 with a specific angular velocity so as to emit scanning light beams 2302a to the f-theta lens 2304. When the scanning light beams 2302a transmit from the f-theta lens 2304, parallel scanning light beams 2304a are obtained. The parallel scanning light beams 2304a emit through the gray filter 231 and the lens array 233 sequentially and reach the light entrance surface 2351 of the LGP 235 uniformly. As shown in FIG. 2, when light transmits through the LGP 231, a portion of light beams 2352a is obtained from the light exit surface 2352 of the LGP 235 and the other portion of light beams emit through the bottom 2353 to the reflector 239 then reflect back to the LGP 235 so as to emit through the light exit surface 2352 of the LGP 235 finally. The light beams 2352a emit through the diffuser sheet 237 and the prism sheet 238 so as to reach the LCD panel 21 and display images.

Referring back to FIG. 1, the LCD panel 21 includes a plurality of pixel regions 211. Each of the pixel regions 211 includes a thin film transistor (TFT) 212. The TFT 212 includes a gate electrode 2121, a source electrode 2122 and a drain electrode 2123. The LCD panel 21 also includes a plurality of scan lines 2131, a plurality of signal lines 2132, and a plurality of pixel electrodes 2133. The scan lines 2131 and the signal lines 2132 cross each other so as to define the pixels. Additionally, each gate electrode 2121 connects to the corresponding scan line 2131 and each source electrode 2122 and drain electrode 2123 individually connect to the signal line 2132 and the pixel electrode 2133.

Scanning signals 251 are generated from the PCB 25 so as to drive each gate electrode 2121 of the LCD panel 21 column by column. Simultaneously, a timing signal 252 is transmitted to the driving motor 2305 of the polygon mirror 2302 so as to control a rotating velocity of the polygon mirror 2302. Additionally, the PCB 25 can receive the feedback signal 253 coming from the optical detectors 2303 so as to modify the rotation velocity of the polygon mirror 2302. In order to coordinate the rotating frequency of the polygon mirror 2302 with the frequency of the scanning signal 251, the feedback signal 253 is used to modify and correct the rotating velocity of the polygon mirror 2302 from time to time as necessary.

In the aforesaid exemplary embodiment, the frequency of the scanning light beams 2302a are corresponding to the frequency of the scanning signal 251. Therefore, during the rotating process of the polygon mirror 2302, when the scanning signal 251 is applied to the LCD panel 21, the scanning light beams 2302a scan the LGP 235 one or more than one time. By using this technique, the blurred image of object movement of image display and the contrast in boundary shape of the displaying object became worse can be reduced.

In addition, scanning light beams 2302a are emitted from the rotating polygon mirror 2302, during the light transmission process, light source 2300 is always turn on instead of changing from a turn on to a turn off state frequently. This protects the light source 2300 from premature aging.

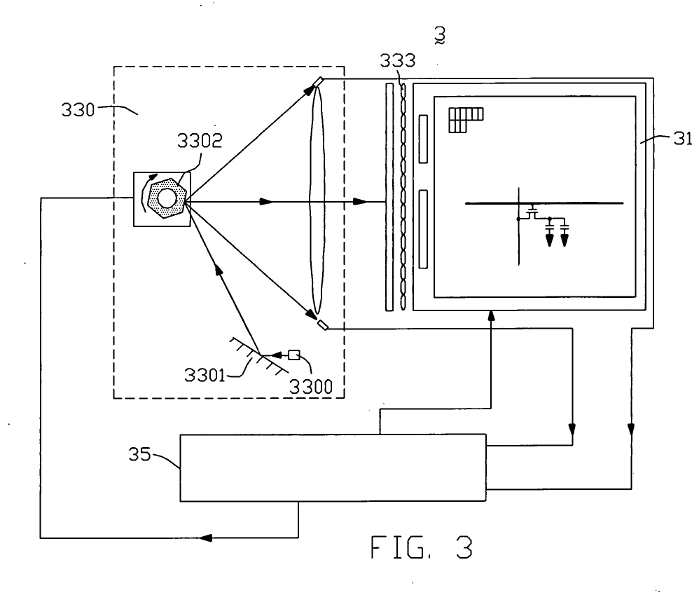

Referring to FIG. 3, this is a schematic plan view of an LCD device 3 illustrating a second embodiment of the present invention. The major difference between the second embodiment and the first embodiment is introducing a plane reflector 3301. The plane reflector 3301 is located between the light source 3300 and the polygon mirror 3302. The plane reflector 3301 is used to reflect light beams coming from the light source 3300 to the polygon mirror 3302. This is because the light source 3300 usually has larger volume and is hard to move (in order to have a stable light emitting quality). Therefore, in this exemplary embodiment, the plane reflector 3300 is configured to adjust the incident light for the polygon mirror 3302 without moving the light source 3300.

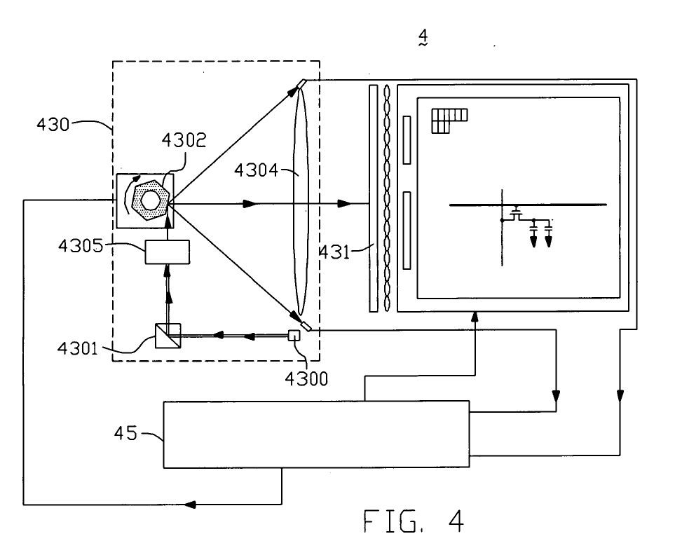

Referring to FIG. 4, this is a schematic plan view of an LCD device 4 illustrating a third embodiment of the present invention. The major difference between the third embodiment and the first embodiment is the light source generator 430. The light source generator 430 includes a polarized beam splitter 4301, a beam combiner 4305. The polarized beam splitter 4301 and the beam combiner 4305 are located between the light source 4300 and the polygon mirror 4302. The light source 4300 is a polarized light source so as to generate polarized light beams. The polarized beam splitter 4301 can be a polarized beams transformer so as to use a polarize sheet to block polarized beams with predetermined direction. The beam combiner 4305 is configured to assemble light beams so as to increase the strength of light.

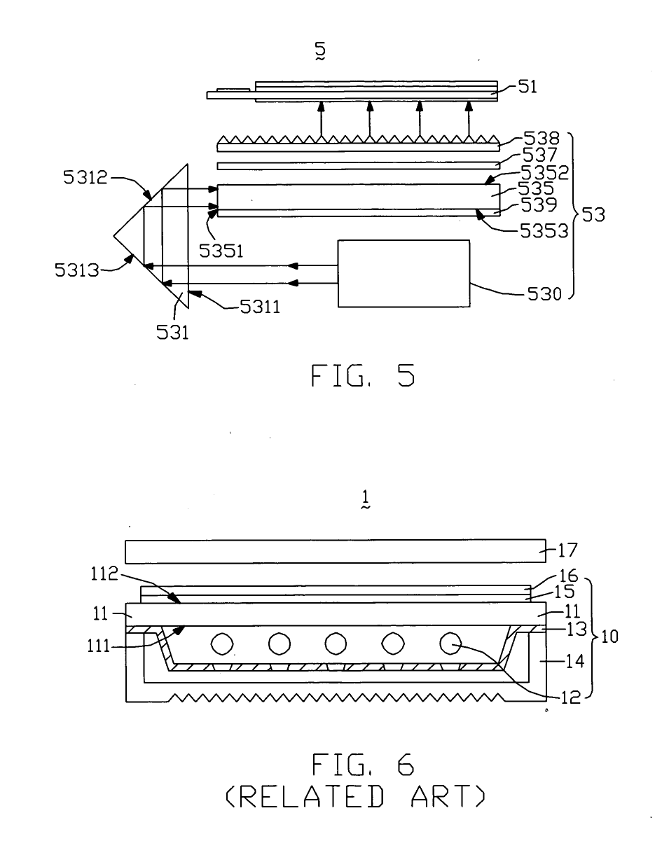

Referring to FIG. 5, this is an exploded, side plan view of an LCD device 5 illustrating a fourth embodiment of the present invention. The backlight module 53 includes a light beam generator 530, a total reflection prism 531, a LGP 535, a diffuser sheet 537, a prism sheet 538, and a reflector 539. It should be noted that the light beam generator 530 is the same as the light beam generator 230 of the first embodiment. The total reflection prism 531 can be configured to replace the gray filter 231 and the lens array 233 of the first embodiment as shown in FIG. 1. The total reflection prism 531 is a triangular prism, wherein a cross-sectional view of the total reflection prism 531 is an isosceles right triangle. As shown in FIG. 5, the side opposite to the right angle of the isosceles right triangle is the bevel 5311 and the two sides adjacent the right angle are the first right angle bevel 5312 and the second right angle bevel 5313 separately. The total reflection prism 531 is located adjacent to the light entrance surface 5351 of the LGP 535.

In the preferred embodiment, the bevel 5311 is parallel to the entrance surface 5351 of the LGP 535 and the first right angle bevel 5312 face the light entrance surface 5351 of the LGP 535 that incident light beams can emit into the total reflection prism 531 from bevel 5311 and transmit out from the bevel 5311 to the LGP 535 by reflecting twice on both the first right angle bevels 5313 and 5312 sequentially. Therefore, the light beam generator 530 can be set under the reflector 539 so as to reduce the side volume of the LCD panel 51.

As would be understood by a person skilled in the art, the foregoing preferred and exemplary embodiments are provided in order to illustrate principles of the present invention rather than limiting the present invention. The above descriptions are intended to cover various modifications and similar arrangements included within the spirit and scope of the appended claims, which scope should be accorded the broadest interpretation so as to encompass all such modifications and similar structures and methods.

We claim:

1. A liquid crystal display (LCD) device, comprising:
an LCD panel;
a backlight module illuminating the LCD panel, comprising:
a light beam generator, comprising:
a light source;
a multi-surface rotating mirror, configured to rotate at a predetermined frequency so as to reflect light beams emitted by the light source; and
a flattened lens, configured for transforming the reflected light beams to parallel light beams;
wherein the LCD panel is driven by scanning signals, and a frequency of the scanning signals is substantially the same as the rotating frequency of the multi-surface rotating mirror.

2. The LCD device as claimed in claim 1, wherein the LCD device further comprising a printed circuit board (PCB) configured to provide the scanning signals.

3. The LCD device as claimed in claim 2, wherein the light beam generator further comprises at least two optical detectors set on two ends of the flattened lens, and the optical detectors are configured to detect light beams and generate feedback signals to the PCB according to a scanning frequency of light beams reflecting from the multi-surface rotating mirror.

4. The LCD device as claimed in claim 1, wherein the backlight module further comprises a gray filter configured to uniform the strength of light coming from the flattened lens.

5. The LCD device as claimed in claim 4, wherein the backlight module further comprises a lens array configured to uniform the strength of light coming from the gray filter.

6. The LCD device as claimed in claim 1, wherein the backlight module further comprises a light guide plate (LGP) configured to introduce light coming from the backlight module to the LCD panel uniformly, wherein the LGP has at least a light entrance surface and at least a light exit surface.

7. The LCD device as claimed in claim 6, wherein the backlight module further comprises a total reflection prism set at a side of the at least a light entrance surface of the LGP, wherein the total reflection prism is configured as an isosceles right-angled triangle and an oblique surface of the total reflection prism faces the light entrance surface of the LGP.

8. The LCD device as claimed in claim 1, wherein the light source is configured to provide polarized light beams.

9. The LCD device as claimed in claim 8, wherein the light source further comprising a polarized beam splitter and a beam combiner.

10. A backlight module for providing light to a display device, comprising:
a light beam generator, comprising:
a light source;
a multi-surface rotating mirror, configured to rotate at a predetermined frequency so as to reflect light beams emitted by the light source; and
a flattened lens configured for transforming the reflecting light beams to parallel light beams; and
a light uniform means utilized to uniform the parallel light beams emitting from the flattened lens;
wherein the display device is configured to be driven by scanning signals, and a frequency of the scanning signals is substantially the same as the rotating frequency of the multi-surface rotating mirror.

11. The backlight module as claimed in claim 10, wherein the light beam generator further comprises at least two optical detectors set on two ends of the flattened lens, and the optical detectors are configured to detect light beams and generate feedback so as to control the rotating frequency of the multi-surface rotating mirror.

12. The backlight module as claimed in claim 10, wherein the light uniform means is a combination of a gray filter and a lens array configured to uniform the strength of light coming from the flattened lens.

13. The backlight module as claimed in claim 10, further comprising a light guide plate (LGP) configured to introduce light coming from the backlight module to the display device uniformly, wherein the LGP has at least a light entrance surface and at least a light exit surface.

14. The backlight module as claimed in claim 13, wherein the light uniform means is a total reflection prism set at a side of the at least a light entrance surface of the LGP, wherein the total reflection prism is configured as an isosceles right-angled triangle and an oblique surface of the total reflection prism faces the light entrance surface of the LGP.

15. The backlight module as claimed in claim 10, wherein the light source is configured to provide polarized light beams.

16. The backlight module as claimed in claim 15, wherein the light source further comprises a polarized beam splitter and a beam combiner.

17. A light beam generator used in a backlight module for a display device, comprising:
a light source;
a multi-surface rotating mirror, configured to rotate at a predetermined frequency so as to reflect light beams from the light source; and
a flattened lens configured for transforming the reflecting light beams to parallel light beams;
wherein the display device is driven by scanning signals, and a frequency of the scanning signals is substantially the same as a rotating frequency of the multi-surface rotating mirror.

18. The light beam generator as claimed in claim 17, wherein the light beam generator further comprises at least two optical detectors set on two ends of the flattened lens, and the optical detectors are configured to detect light beams and generate feedback signals so as to control the rotating frequency of the multi-surface rotating mirror.

19. The light beam generator as claimed in claim 17, wherein the light source is configured to provide polarized light beams.

20. The light beam generator as claimed in claim 17, wherein the light source further comprises a polarized beam splitter and a beam combiner.
